(19) United States
(12) Patent Application Publication
(10) Pub. No.: US 2009/0323719 A1
(43) Pub. Date: Dec. 31, 2009

(54) METHODS AND APPARATUS FOR TRANSFORMING FIRST TRANSPORT STREAM OF FIRST FORMAT INTO SECOND TRANSPORT STREAM OF SECOND FORMAT BY EMULATING ARRIVAL TIME STAMP INFORMATION

(76) Inventors: Ya-Ching Yang, Taipei City (TW); Ching-Yu Tsai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/146,465

(22) Filed: Jun. 26, 2008

(51) Int. Cl. H04J 3/16

(52) U.S. Cl. 370/466

(57) ABSTRACT

A method for transforming a first transport stream of a first format into a second transport stream of a second format includes deriving at least one program clock reference (PCR) value from the first transport stream, and calculating an arrival time stamp value according to the PCR value. In addition, the method further includes generating a header carrying at least the arrival time stamp value, and outputting the second transport stream. Additionally, the second transport stream comprises the header and a second packet corresponding to a first packet of the first transport stream.

### BACKGROUND

The present invention relates to stream conversion between different formats, and more particularly, to methods and apparatus for transforming a first transport stream of a first format into a second transport stream of a second format by emulating arrival time stamp information.

As Blu-ray Discs (BDs) have become practical for video data recording, the need for recording transport streams derived from various sources (e.g. broadcasting tuner, network streaming, or a storage device such as a flash memory) to a BD has arisen accordingly. As a result, transforming a transport stream complying with conventional specifications such as ISO/IEC 13818-1 specifications into a Blu-ray Disc Audio Visual Moving Picture Experts Group phase 2 (BDAV MPEG-2) transport stream has become an essential issue.

FIG. 1 illustrates one of a plurality of source packets of the aforementioned BDAV MPEG-2 transport stream according to the related art. A header TP_extra_header in the source packet shown in FIG. 1 carries copy permission information and an arrival time stamp (ATS) value arrival_time_stamp. According to BD specifications, arrival_time_stamp represents the arrival time of a specific byte to a specific filter. In addition, the notation arrival_time_stamp(k) is further utilized for representing a sample value of a count value arrival_time_clock(k) of an arrival time clock counter, and can be expressed as:

arrival_time_stamp(k)=arrival_time_clock(k) % 2³⁰;

where k represents the first byte of transport packets. The aforementioned arrival time clock counter is a counter that counts the pulses of a specific frequency. Please refer to BD specifications for more information.

As a conventional transport stream such as a transport stream complying with ISO/IEC 13818-1 specifications lacks the header TP_extra_header shown in FIG. 1, the header TP_extra_header should be generated while converting the conventional transport stream into the BDAV MPEG-2 transport stream. More specifically, while converting the conventional transport stream into the BDAV MPEG-2 transport stream, a proper value of the arrival time stamp value arrival_time_stamp should be determined in advance in order to generate the header TP_extra_header in the BDAV MPEG-2 transport stream.

Please refer to FIG. 2. FIG. 2 illustrates a conventional method for generating the arrival time stamp value arrival_time_stamp in the header TP_extra_header to be appended to the conventional transport stream such as a transport packet stream, where the transport packet stream shown in FIG. 2 complies with conventional specifications such as ISO/IEC 13818-1 specifications, and the source packet stream shown in FIG. 2 represents the BDAV MPEG-2 transport stream mentioned above.

As shown in FIG. 2, the conventional method utilizes a system time counter value of a system time counter at the arrival time of the conventional transport stream as the arrival time stamp value arrival_time_stamp. However, this conventional method is invalid unless a condition where the conventional transport stream is transmitted at a constant broadcasting rate is satisfied. For example, when the conventional transport stream is a transport stream derived from a storage media, rather than from broadcasting, there is no constant broadcasting rate that ensures a proper value of the arrival time stamp value arrival_time_stamp.

Therefore, the conventional method shown in FIG. 2 cannot be applied to the conventional transport stream since no proper arrival time information regarding the conventional transport stream can be derived.

### SUMMARY

It is therefore an objective of the claimed invention to provide methods and apparatus for transforming a first transport stream of a first format into a second transport stream of a second format to solve the above-mentioned problem.

An exemplary embodiment of a method for transforming a first transport stream of a first format into a second transport stream of a second format comprises deriving at least one program clock reference (PCR) value from the first transport stream and calculating an arrival time stamp value according to the PCR value, and further comprises generating a header that carries at least the arrival time stamp value and outputting the second transport stream. In addition, the second transport stream comprises the header and a second packet corresponding to a first packet of the first transport stream.

An exemplary embodiment of an apparatus for transforming a first transport stream of a first format into a second transport stream of a second format comprises a processing circuit and an output stage that is coupled to the processing circuit. The processing circuit is utilized for deriving at least one PCR value from the first transport stream, calculating an arrival time stamp value according to the PCR value, and generating a header carrying at least the arrival time stamp value. In addition, the output stage is utilized for outputting the second transport stream. Additionally, the second transport stream comprises the header and a second packet corresponding to a first packet of the first transport stream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a packet of a Blu-ray Disc Audio Visual Moving Picture Experts Group phase 2 (BDAV MPEG-2) transport stream according to the related art.

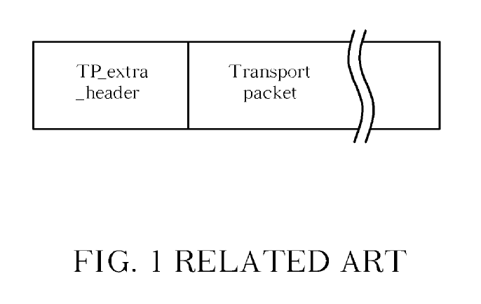

FIG. 2 illustrates a conventional method for generating an arrival time stamp value in a header to be appended to a conventional transport stream such as a transport packet stream, where the conventional method utilizes a system time counter value of a system time counter at the arrival time of the conventional transport stream as the arrival time stamp value.

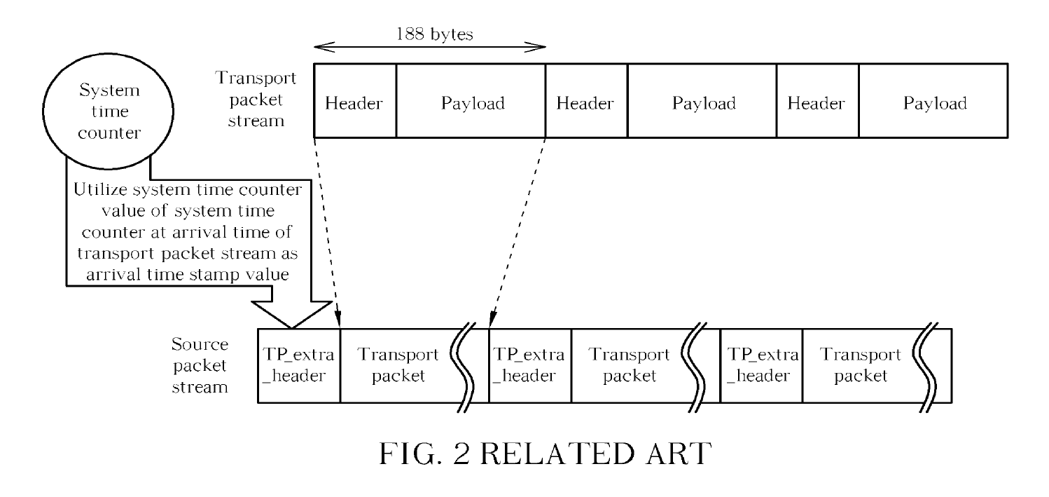

FIG. 3 is a diagram of an apparatus for transforming a first transport stream of a first format into a second transport stream of a second format according to a first embodiment of the present invention.

FIG. 4 is a flowchart of a method for transforming a first transport stream of a first format into a second transport stream of a second format according to one embodiment of the present invention.

FIG. 5 illustrates details of the MPEG-2 Transport Stream syntax defined in ISO/IEC 13818-1 specifications according to the related art.

FIG. 6 illustrates exemplary details of the method shown in FIG. 4 in a situation where two PCR values are utilized.

FIG. 7 illustrates an example of a situation where the PCR value only exists in a portion of transport packets of a transport packet stream as defined in FIG. 5.

FIG. 8 illustrates corresponding expressions of the arrival time stamp value derived in the situation shown in FIG. 7 for a plurality of source packets in the second transport stream of the first embodiment.

FIG. 9 is a diagram of an apparatus for transforming a first transport stream of a first format into a second transport stream of a second format according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

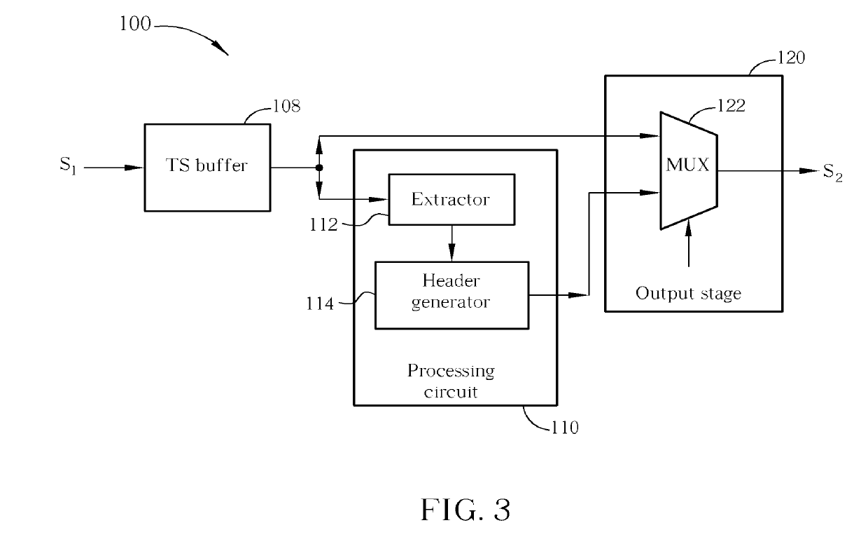

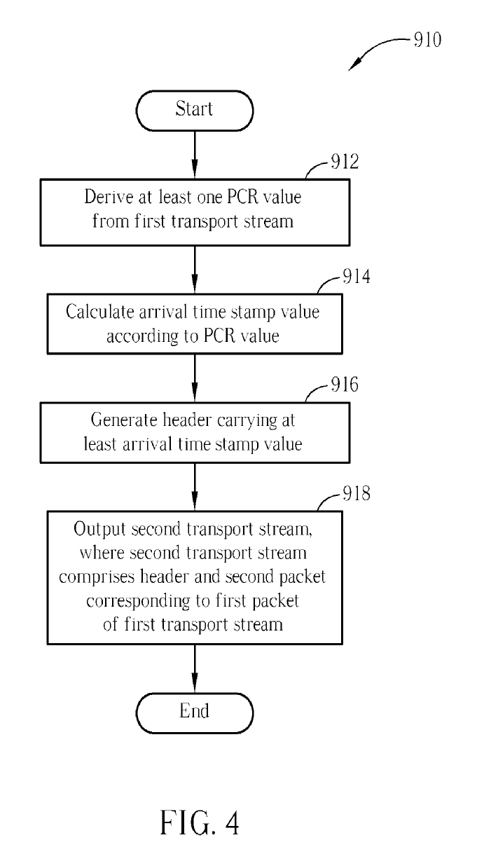

Please refer to FIG. 3 and FIG. 4. FIG. 3 is a diagram of an apparatus 100 for transforming a first transport stream S₁ of a first format into a second transport stream S₂ of a second format according to a first embodiment of the present invention. FIG. 4 is a flowchart of a method 910 for transforming a first transport stream of a first format into a second transport stream of a second format according to one embodiment of the present invention, where the method 910 can be implemented by utilizing the apparatus 100 shown in FIG. 3, and can be applied to the first embodiment.

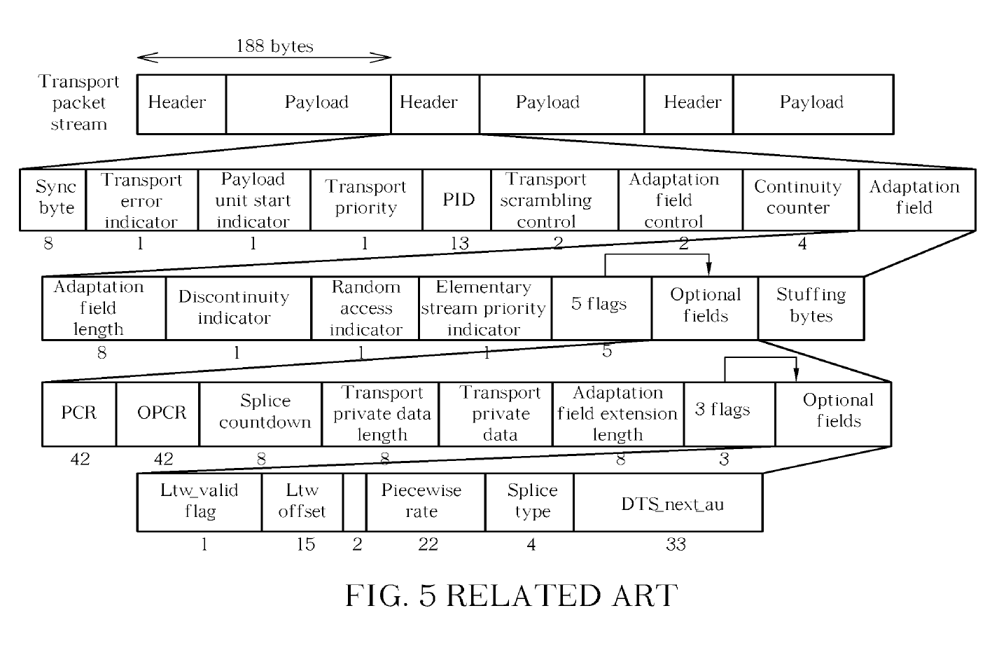

According to the first embodiment, the first transport stream S₁ complies with ISO/IEC 13818-1 specifications, and the second transport stream S₂ complies with Blu-ray Disc (BD) specifications. In this embodiment, the first transport stream S₁ is a conventional transport stream such as a Moving Picture Experts Group phase 2 (MPEG-2) transport stream complying with the MPEG-2 Transport Stream syntax shown in FIG. 5, and the second transport stream S₂ is a Blu-ray Disc Audio Visual MPEG-2 (BDAV MPEG-2) transport stream.

Please note that a PCR field illustrated in the lower left portion of FIG. 5 is utilized for carrying a 42-bit program clock reference (PCR) value, which indicates the intended time of arrival of a transport packet carrying the PCR value at an input of a system target decoder. Although the PCR value does not represent the real arrival time of the corresponding packet in the BDAV MPEG-2 transport stream, the apparatus 100 of this embodiment utilizes the PCR value to emulate the real arrival time of at least one packet when needed, so as to solve the related art problem mentioned above.

As shown in FIG. 3, the apparatus 100 comprises a buffer such as a transport stream (TS) buffer 108, a processing circuit 110, and an output stage 120, where the processing circuit 110 of this embodiment comprises an extractor 112 and a header generator 114, and the output stage 120 of this embodiment comprises a multiplexer 122. The TS buffer 108 buffers packets of the first transport stream S₁, and outputs the buffered packets as packets of the second transport stream S₂. In this embodiment, the packets of the first transport stream S₁ are referred to as transport packets, and the packets of the second transport stream S₂ are referred to as source packets.

Regarding the processing circuit 110, in Step 912, the extractor 112 derives at least one PCR value from the first transport stream S₁. In addition, in Step 914, the header generator 114 of this embodiment calculates an arrival time stamp value such as the aforementioned arrival time stamp value arrival_time_stamp according to the PCR value, where the arrival time stamp value arrival_time_stamp may be calculated according to at least one PCR value derived from one or more packets of the first transport stream S₁. Additionally, in Step 916, the header generator 114 of this embodiment further generates a header such as the aforementioned header TP_extra_header, where the header TP_extra_header carries the copy permission information mentioned above and the arrival time stamp value arrival_time_stamp.

In Step 918, the output stage 120 outputs the second transport stream S₂, where the second transport stream S₂ comprises the header TP_extra_header and a second packet corresponding to a first packet of the first transport stream S₁. More specifically, when the first packet (i.e. a transport packet in this embodiment) is input into the TS buffer 108, the TS buffer 108 buffers the first packet for being later output as the second packet. Thus, the second packet carries the same video content as the first packet. Regarding the output stage 120, the multiplexer 122 multiplexes the header TP_extra_header received from the processing circuit 110 and then multiplexes the second packet, so as to generate a combined packet comprising the header TP_extra_header and the second packet as a source packet of the second transport stream S₂ of this embodiment.

Some details of the aforementioned PCR value are described herein for reference. The PCR value represent a value encoded in a PCR field that indicates the time t(i), where i is an index of the byte containing the last bit of a program_clock_reference_base field. The PCR value is defined according to the following equation:

PCR(i)=PCR_base(i)×300+PCR_ext(i);

where:

PCR_base(i)=((system_clock_frequency×t(i)) DIV 300)% 2³³; and

PCR_ext(i)=((system_clock_frequency×t(i)) DIV 1)% 300.

The PCR field carrying the PCR value is encoded in two parts: a first part carrying the program clock reference base PCR_base, in units of the period of 1/300 times the system clock frequency, called program_clock_reference_base; and a second part carrying the program clock reference extension PCR_ext, in units of the system clock frequency, called program_clock_reference_extension.

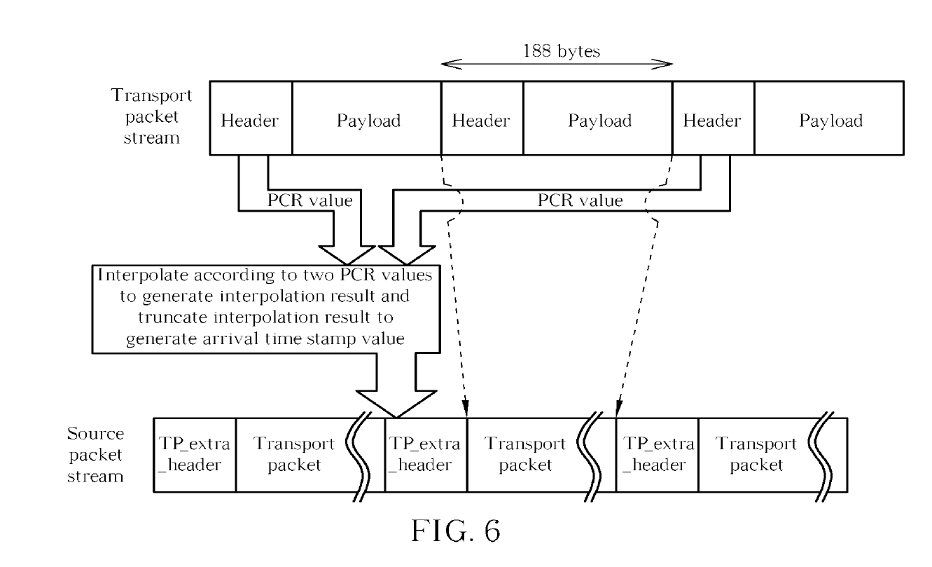

In general, the PCR value only exists in a portion of transport packets of a transport packet stream as defined in FIG. 5 since the PCR field is one of a plurality of optional fields within an adaptation field shown in the upper right portion of FIG. 5. Interpolation according to two PCR values can be applied when needed. Thus, in Step 912, the extractor 112 derives two PCR values from the first transport stream S₁. In addition, in Step 914, the processing circuit 110 interpolates according to the two PCR values to generate an interpolation result, and truncates the interpolation result to generate the arrival time stamp value arrival_time_stamp. FIG. 6 illustrates exemplary details of the method 910 shown in FIG. 4 in this situation.

More particularly, the processing circuit 110 calculates the arrival time stamp value arrival_time_stamp not only according to the two PCR values, but also according to a current packet number and two packet numbers of two packets that respectively carry the two PCR values. The processing circuit 110 calculates the arrival time stamp value arrival_time_stamp according to the following equation:

ATS=(PCR_{b}+(PCRₐ−PCR_{b})×(PN_{c}−PN_{b})/(PNₐ−PN_{b}))% 2₃₀;

where ATS represents the arrival time stamp value arrival_time_stamp, PN_{c} represents the current packet number, PCRₐ and PCR_{b} represent the two PCR values, and PNₐ and PN_{b} represent the two packet numbers of the two packets that respectively carry the two PCR values PCRₐ and PCR_{b}.

According to this embodiment, one of the packet numbers PNₐ and PN_{b} is greater than the current packet number PN_{c}, and the other of the packet numbers PNₐ and PN_{b} is less than the current packet number PN_{c}. For example, within the first transport stream S₁ input into the TS buffer 108, the current packet having the current packet number PN_{c} comes after the packet that carries the PCR value PCR_{b}, and the packet that carries the PCR value PCRₐ comes after the current packet having the current packet number PN_{c}, where the subscript ‘b’ of notations such as PCR_{b} and PN_{b} stands for “before”, and the subscript ‘a’ of notations such as PCRₐ and PNₐ stands for “after”

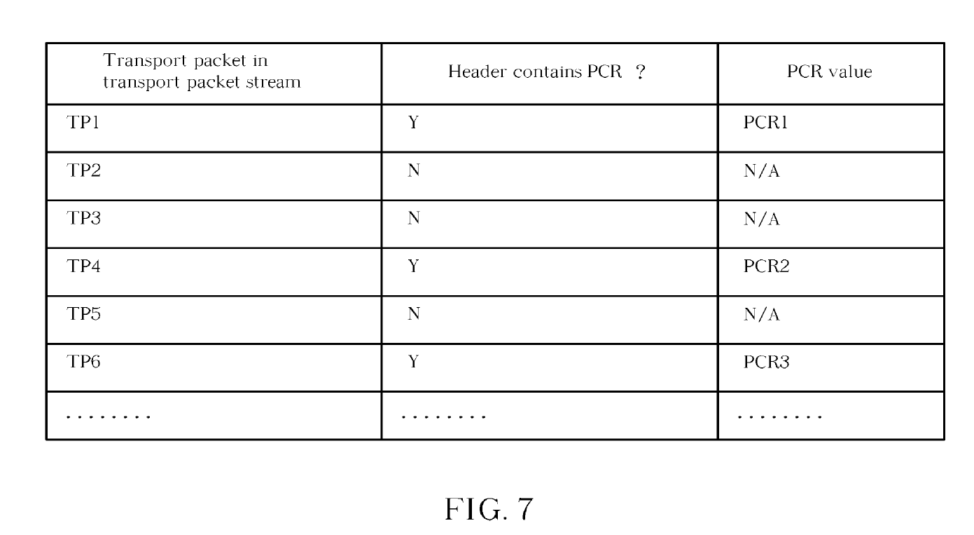

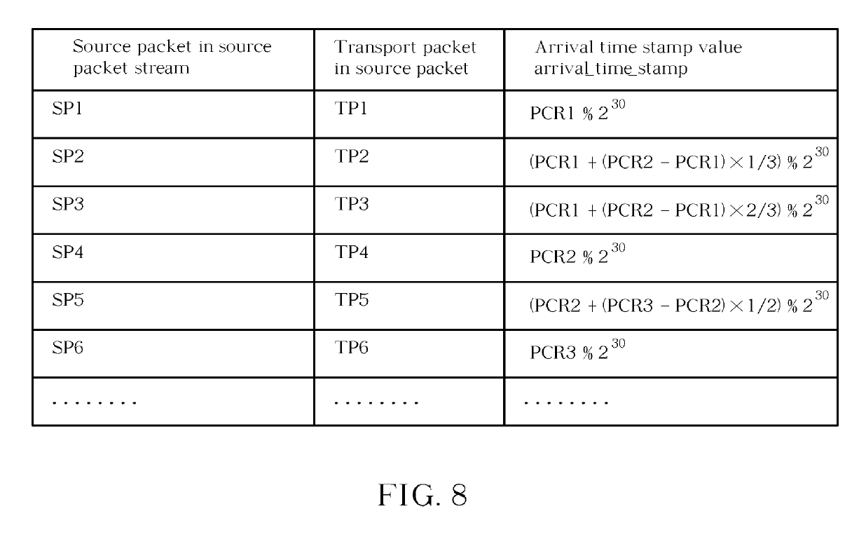

Taking a situation shown in FIG. 7 as an example, within a plurality of transport packets TP1, TP2, TP3, TP4, TP5, TP6, . . . , etc. in the transport packet stream (i.e. the first transport stream S₁ of this embodiment), the transport packets TP1, TP4, and TP6 carry PCR values PCR1, PCR2, and PCR3, respectively. According to the calculations disclosed above, the corresponding expressions of the arrival time stamp value arrival_time_stamp derived in the situation shown in FIG. 7 for a plurality of source packets SP1, SP2, SP3, SP4, SP5, SP6, . . . , etc. in the source packet stream (i.e. the second transport stream S₂ of this embodiment) are illustrated as shown in FIG. 8.

According to a variation of this embodiment, both the packet numbers PNₐ and PN_{b} are greater than the current packet number PN_{c}. In addition, according to another variation of this embodiment, both the packet numbers PNₐ and PN_{b} are less than the current packet number PN_{c}. Similar descriptions for these variations are not detailed here.

It should be noted that, according to another variation of this embodiment, the packets of the first transport stream S₁ can be varied (e.g. re-encoded for correction or trans-coded for type transformation) while being converted into the packets of the second transport stream S₂. For example, while being converted into the packets of the second transport stream S₂, the packets of the first transport stream S₁ can be re-encoded for correction, or trans-coded for type transformation. Similar descriptions for this variation are not detailed here.

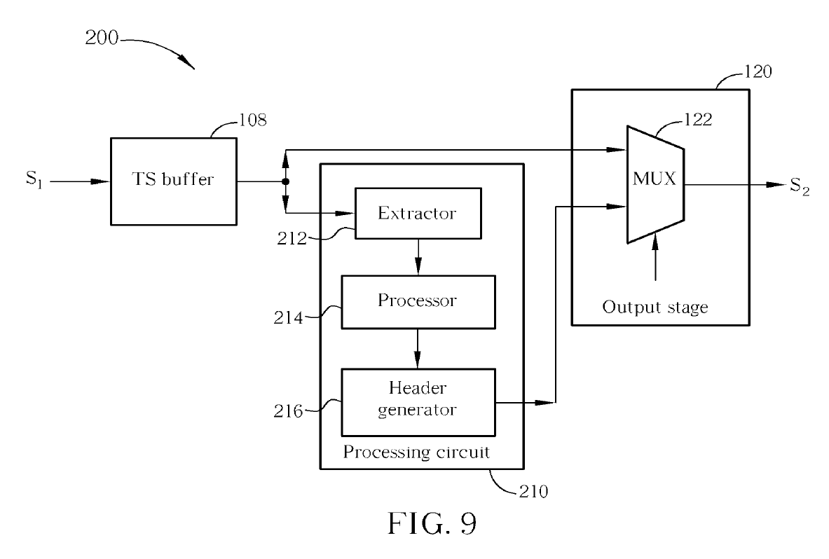

FIG. 9 is a diagram of an apparatus 200 for transforming a first transport stream of a first format (e.g. the aforementioned first transport stream S₁) into a second transport stream of a second format (e.g. the aforementioned second transport stream S₂) according to a second embodiment of the present invention, where the second embodiment is a variation of the first embodiment. Similarly, the method 910 can be implemented by utilizing the apparatus 200 shown in FIG. 9, and can be applied to the second embodiment. Differences between the second embodiment and the first embodiment are described as follows.

The aforementioned processing circuit 110 is replaced with another processing circuit 210 comprising an extractor 212, a processor 214, and a header generator 216, with the extractor 212 performing the same function as the extractor 112 mentioned above in Step 912. However, in Step 914, it is the processor 214 that calculates an arrival time stamp value such as the aforementioned arrival time stamp value arrival_time_stamp according to the PCR value, where the header generator 216 of this embodiment generates a header such as the aforementioned header TP_extra_header carrying the copy permission information mentioned above and the arrival time stamp value arrival_time_stamp in Step 916. Similar descriptions for the second embodiment are not detailed here.

According to a variation of this embodiment, the processor 214 is a micro processing unit (MPU) that is capable of controlling the whole apparatus 200, where the processing circuit 210 represents a logically defined block. Similar descriptions for this variation are not detailed here.

In contrast to the related art, the present invention methods and apparatus emulate arrival time stamp information (e.g. the arrival time stamp value arrival_time_stamp) rather than inserting arrival time stamps that are derived according to a system clock counter. As a result, when the conventional transport stream is a transport stream derived from a storage media rather than from broadcasting, the present invention methods and apparatus still work well without introducing the related art problems.

It is an advantage of the claimed invention that the present invention methods and apparatus emulate the arrival time stamp information according to program clock reference information such as the abovementioned PCR value of the original transport stream, so the transport stream conversion can be properly performed for various types of transport streams, even for transport streams comprising packets with unknown incoming times.

Those skilled in the art will readily observe that numerous modifications and alterations of the device and method may be made while retaining the teachings of the invention.

What is claimed is:

1. A method for transforming a first transport stream of a first format into a second transport stream of a second format, the method comprising:
deriving at least one program clock reference (PCR) value from the first transport stream;
calculating an arrival time stamp value according to the PCR value;
generating a header carrying at least the arrival time stamp value; and
outputting the second transport stream, wherein the second transport stream comprises the header and a second packet corresponding to a first packet of the first transport stream.

2. The method of claim 1, wherein the PCR value comprises two PCR values; and in the step of calculating the arrival time stamp value, the arrival time stamp value is calculated according to the two PCR values, a current packet number, and two packet numbers of two packets that respectively carry the two PCR values.

3. The method of claim 2, wherein in the step of calculating the arrival time stamp value, the arrival time stamp value is calculated according to the following equation:
ATS=(PCR_{b}+(PCRₐ−PCR_{b})×(PN_{c}−PN_{b})/(PNₐ−PN_{b}))% 2₃₀;
where ATS represents the arrival time stamp value, PN_{c} represents the current packet number, PCRₐ and PCR_{b} represent the two PCR values, and PNₐ and PN_{b} represent the two packet numbers of the two packets that respectively carry the two PCR values PCRₐ and PCR_{b}.

4. The method of claim 3, wherein one of the packet numbers PNₐ and PN_{b} is greater than the current packet number PN_{c}, and the other one of the packet numbers PNₐ and PN_{b} is less than the current packet number PN_{c}.

5. The method of claim 3, wherein both the packet numbers PNₐ and PN_{b} are greater than the current packet number PN_{c}; or both the packet numbers PNₐ and PN_{b} are less than the current packet number PN_{c}.

6. The method of claim 1, wherein the PCR value comprises two PCR values; and the step of calculating the arrival time stamp value further comprises:
interpolating according to the two PCR values to generate an interpolation result; and
truncating the interpolation result to generate the arrival time stamp value.

7. The method of claim 1, wherein the header further carries copy permission information.

8. The method of claim 1, wherein the second packet carries the same video content as the first packet.

9. The method of claim 8, further comprising:
buffering the first packet; and
outputting the buffered first packet as the second packet.

10. The method of claim 1, wherein the first transport stream complies with ISO/IEC 13818-1 specifications; and/or the second transport stream complies with Blu-ray Disc (BD) specifications.

11. An apparatus for transforming a first transport stream of a first format into a second transport stream of a second format, the apparatus comprising:
a processing circuit for deriving at least one program clock reference (PCR) value from the first transport stream, calculating an arrival time stamp value according to the PCR value, and generating a header carrying at least the arrival time stamp value; and
an output stage, coupled to the processing circuit, for outputting the second transport stream, wherein the second transport stream comprises the header and a second packet corresponding to a first packet of the first transport stream.

12. The apparatus of claim 11, wherein the PCR value comprises two PCR values; and the processing circuit calculates the arrival time stamp value according to the two PCR values, a current packet number, and two packet numbers of two packets that respectively carry the two PCR values.

13. The apparatus of claim 12, wherein the processing circuit calculates the arrival time stamp value according to the following equation:
ATS=(PCR_{b}+(PCRₐ−PCR_{b})×(PN_{c}−PN_{b})/(PNₐ−PN_{b}))% 2₃₀;
where ATS represents the arrival time stamp value, PN_{c} represents the current packet number, PCRₐ and PCR_{b} represent the two PCR values, and PNₐ and PN_{b} represent the two packet numbers of the two packets that respectively carry the two PCR values PCRₐ and PCR_{b}.

14. The apparatus of claim 13, wherein one of the packet numbers PNₐ and PN_{b} is greater than the current packet number PN_{c}, and the other one of the packet numbers PNₐ and PN_{b} is less than the current packet number PN_{c}.

15. The apparatus of claim 13, wherein both the packet numbers PNₐ and PN_{b} are greater than the current packet number PN_{c}; or both the packet numbers PNₐ and PN_{b} are less than the current packet number PN_{c}.

16. The apparatus of claim 11, wherein the PCR value comprises two PCR values; and the processing circuit interpolates according to the two PCR values to generate an interpolation result, and truncates the interpolation result to generate the arrival time stamp value.

17. The apparatus of claim 11, wherein the processing circuit comprises:
an extractor for deriving the PCR value from the first transport stream; and
a header generator, coupled to the extractor, for calculating the arrival time stamp value according to the PCR value, and generating the header carrying at least the arrival time stamp value.

18. The apparatus of claim 11, wherein the processing circuit comprises:
an extractor for deriving the PCR value from the first transport stream;
a processor, coupled to the extractor, for calculating the arrival time stamp value according to the PCR value; and
a header generator, coupled to the processor, for generating the header carrying at least the arrival time stamp value.

19. The apparatus of claim 11, further comprising:
a buffer for buffering the first packet, and outputting the buffered first packet as the second packet;
wherein the output stage comprises:
a multiplexer, coupled to the buffer and the processing circuit, for multiplexing the header and then multiplexing the second packet to generate the second transport stream.

20. The apparatus of claim 11, wherein the first transport stream complies with ISO/IEC 13818-1 specifications; and/or the second transport stream complies with Blu-ray Disc (BD) specifications.
